(19) United States
(12) Patent Application Publication
(10) Pub. No.: US 2009/0324960 A1
(43) Pub. Date: Dec. 31, 2009

(54) METHOD OF MANUFACTURING A BITUMINOUS MEMBRANE

(76) Inventors: Amélie Richir, Perwez (BE); Michel Getlichermann, Perwez (BE); Eric Bertrand, Perwez (BE)

Correspondence Address: JACOBSON HOLMAN PLLC, 400 SEVENTH STREET N.W., SUITE 600, WASHINGTON, DC, 20004, US

(21) Appl. No.: 12/457,395

(22) Filed: Jun. 9, 2009

(30) Foreign Application Priority Data
Jun. 10, 2008 (BE) 2008/0317
Jun. 13, 2008 (EP) 08158188.6

(51) Int. Cl. B32B 27/04; B29C 65/48

(52) U.S. Cl. 428/422; 156/285

(57) ABSTRACT

Method of manufacturing a bituminous membrane provided with photovoltaic cells, according to which said photovoltaic cells are applied to one face of a reinforcement provided on the surface with an anti-exudation layer and in that next a bituminous mass is applied to the other face of said reinforcement.

The present invention concerns a method of manufacturing a bituminous membrane provided with photovoltaic cells.

Such a method is known from the international application WO 2007/055963. In the known method, the photovoltaic cells are applied to the membrane after the manufacture of the latter. As the bituminous membrane is placed on a roof as a sealing element, the presence of photovoltaic cells thus makes it possible to have on the roof photovoltaic cells that can capture sunlight and thus convert solar energy into electrical energy that can then be used by the occupants of the building on the roof of which the membrane is laid. It should be remarked that there also exist synthetic membranes that include photovoltaic cells on their surface, but they do not include bitumen.

A drawback of the known method is that the photovoltaic cells must be applied after the membrane is laid, which gives rise to a higher installation cost. In addition, the cells must be applied carefully, otherwise the risk that they may become detached over time is too high.

The object of the invention is to produce a method of manufacturing a bituminous membrane provided with photovoltaic cells and hence a finished product with a guarantee of performance in relation to adhesion, sealing and electrical efficiency over time.

To this end, a method according to the invention is characterized in that said photovoltaic cells are applied to one face of a reinforcement provided on the surface with an anti-exudation layer and in that a bituminous mass is then applied to the other face of said reinforcement. By applying the photovoltaic cells to one face of a reinforcement provided with an anti-exudation layer, a reinforcement carrying photovoltaic cells is obtained that can, as such, be used for applying the bitumen to the face other than the one where the anti-exudation layer is applied. The bitumen thus does not come into direct contact with the cells when the membrane is manufactured by machine. In addition, as the cells are applied to the face where the anti-exudation layer is situated, the cells cannot easily become detached due to a migration of oil. This is because the anti-exudation layer considerably limits the migration of oil in the bitumen. As the oil cannot pass through the anti-exudation layer, it cannot delaminate the cells.

A first preferential embodiment of a method according to the invention is characterized in that the photovoltaic cells are adhesively bonded to said reinforcement. The use of adhesive allows rapid and machine application of the cells to the reinforcement.

A second preferential embodiment of a method according to the invention is characterized in that a first layer of adhesive is first of all applied to said reinforcement before applying the photovoltaic cells thereto, which are then covered with a second layer of adhesive and a protective layer. The cells are thus sandwiched between two layers of adhesive and one protective layer. This affords not only good adhesion of the cells to the reinforcement but also protection of the photovoltaic cells.

A third preferential embodiment of a method according to the invention is characterized in that, for the first and second layers of adhesive, a film of ethylene vinyl acetate is used. Such a film has good resistance to heat, which is advantageous when bitumen is applied.

A fourth preferential embodiment of a method according to the invention is characterized in that the photovoltaic cells are applied in the form of films. This affords complete adhesion of the cells to the reinforcement.

A fifth preferential embodiment of a method according to the invention is characterized in that the photovoltaic cells are applied by lamination to the reinforcement. This makes it possible to make the cells adhere firmly to the reinforcement.

The invention will now be described in more detail with the help of the drawings, which illustrate a preferential embodiment of the method according to the invention, and of a membrane.

In the drawings:

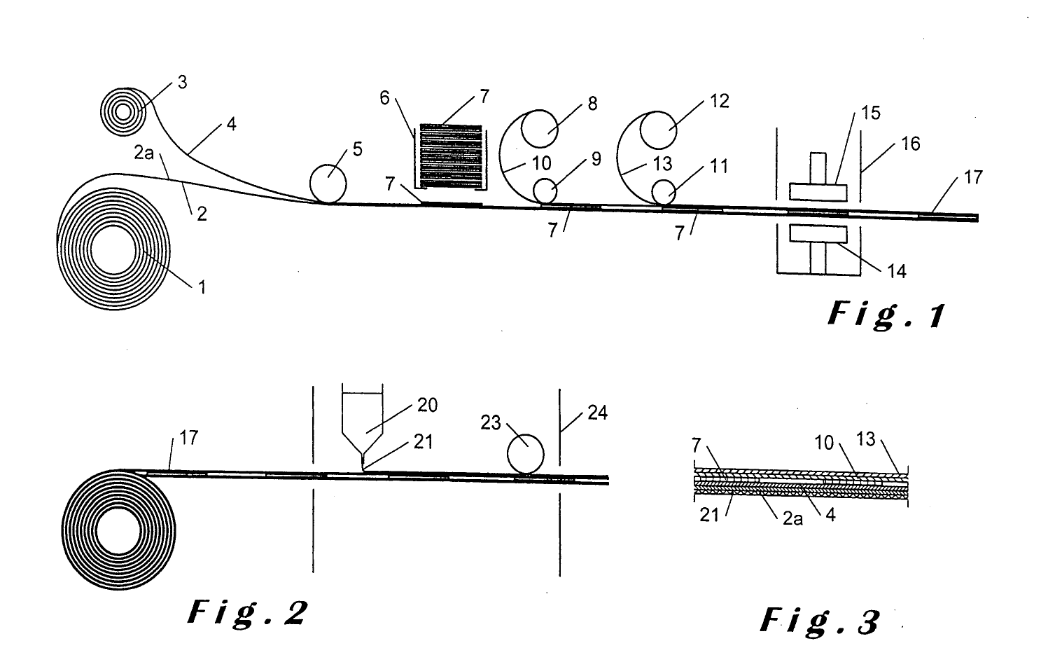

FIG. 1 illustrates a preferential embodiment of the method for applying the photovoltaic cells to a reinforcement;

FIG. 2 illustrates an example showing how the bituminous mass is applied to the reinforcement, and

FIG. 3 illustrates a transverse section through a membrane obtained by applying the method according to the invention.

In the drawings the same reference has been allocated the same element or to a similar element.

In the method according to the invention, a reinforcement 2 wound on a first coil 1 is taken. This reinforcement can be formed by a non-woven polyester fabric where necessary reinforced by glass or polyester fibers. The reinforcement can also be formed by a glass cloth. However, it goes without saying that reinforcements with other compositions can be used. The reinforcement must of course be able to form a support for the bituminous mass of a bituminous membrane.

One face 2a of the reinforcement is provided on the surface with an anti-exudation layer. This layer prevents the migration of oil, present in the bituminous mass, to the surface of the membrane. The properties and manufacture of such an exudation layer are for example described in the patent EP 0 876 532 or in the patent application WO 2004/020107. This anti-exudation layer can also be produced using polymers other than those described in the documents cited.

The reinforcement 2 provided with the anti-exudation layer is unwound from the first coil and directed to a first roller 5 where there is also brought a first film 4 of adhesive unwound from a second coil 3. The first film is preferably a film of ethylene vinyl acetate (EVA). By means of the first roller 5, the first film 4 is applied against the reinforcement 2. The latter, provided with the first film, then passes to a station 6 where photovoltaic cells 7 in the form of plates are placed on the reinforcement. From a third coil 8, a second film 10 is unwound, also preferably an EVA film, which is applied by means of a second roller 9 to the reinforcement provided with the photovoltaic cells. Thus the cells are sandwiched between the first and second films of adhesive. Finally, from a fourth coil 12, a film 13 of polytetrafluoroethylene (PTFE) is unwound, which is applied by means of a third roller 11 to the second film 10. The film 13 thus protects the cells present between the films 10 and 13.

The assembly formed by reinforcements, cells and films subsequently passes through the lamination device 16 where, by means of presses 14 and 15, the assembly is pressed in order to form a coherent assembly, forming the reinforcement 17 provided with the anti-exudation layer. The lamination preferably takes place in a temperature range situated between 120° C. and 180° C., preferably at 150° C., the fusion temperature of the films. The lamination is preferably done under vacuum and for a period situated between 10 and 20 minutes. Thus an integrated coherent structure is obtained.

It goes without saying that embodiments other than those that have just been described with the help of FIG. 1 can be envisaged. Thus it is also possible to supply the photovoltaic cells in the form of films, thus allowing a continuous manufacturing method. It is also possible to use other types of adhesive having good resistance to temperatures above 120° C. for bonding the photovoltaic cells to the reinforcement provided with the anti-exudation layer.

It can also be envisaged applying the adhesive by spraying.

FIG. 2 illustrates the application of a bituminous mass to the reinforcement 17 provided with the anti-exudation layer. The reinforcement, with the photovoltaic cells turned downwards, passes through a station 24 provided with a system 20 of adding the bituminous mass 21. In the station 24, the bituminous mass 21 is poured onto the face of the reinforcement other than the one where the anti-exudation layer and the photovoltaic cells are applied. Naturally the reinforcement with the photovoltaic cells can also be turned upwards.

After application of the bituminous mass 21, the assembly passes under a roller 23 that equalizes and cools the bituminous mass. The application, even at a minimum temperature of 180° C., of the bituminous mass affects neither the anti-exudation layer nor the EVA and PTFE films, which withstand this temperature. This is because the barrier effect of the anti-exudation layer enables the complex consisting of reinforcement and photovoltaic cells to withstand the application of a bituminous mass at temperatures above the melting point of the EVA adhesive. The result is non-impairment of the adhesion and of the electrical efficiency of the photovoltaic panel.

The bituminous membrane, when it is applied to the roof, will thus, by virtue of the presence of the photovoltaic cells, be able to serve as an energy source by capturing solar energy. Since the photovoltaic cells are situated on the other side of the reinforcement than the one where the bituminous mass is applied, and the reinforcement is provided with an anti-exudation layer, any migration of oil will not be able to detach the photovoltaic cells. Since the membrane with its photovoltaic cells forms an assembly, it can be unwound as it stands on the roof, which considerably facilitates installation.

1. Method of manufacturing a bituminous membrane provided with photovoltaic cells, characterized in that the said photovoltaic cells are applied to one face of a reinforcement provided on the surface with an anti-exudation layer and in that next a bituminous mass is applied to the other face of said reinforcement.

2. Manufacturing method according to claim 1, characterized in that the photovoltaic cells are adhesively bonded to said reinforcement.

3. Manufacturing method according to claim 2, characterized in that first of all a first layer of adhesive is applied to said reinforcement before applying the photovoltaic cells thereto, which are then covered with a second layer of adhesive and a protective layer.

4. Manufacturing method according to claim 3, characterized in that, for the first and second layers of adhesive, a film of ethylene vinyl acetate is used.

5. Manufacturing method according to claim 3, characterized in that, for the protective layer, a polytetrafluoroethylene film is used.

6. Manufacturing method according to claim 1, characterized in that the photovoltaic cells are applied in the form of films.

7. Manufacturing method according to claim 1, characterized in that the photovoltaic cells are applied by lamination on the reinforcement.

8. Manufacturing method according to claim 7, characterized in that the lamination is carried out at a temperature of between 120° C. and 180° C. and for a period of time of between 10 and 20 minutes.

9. Manufacturing method according to claim 7, characterized in that the lamination is carried out under vacuum.

10. Bituminous membrane obtained by applying the method according to claim 1.
